(19) United States
(12) Patent Application Publication
(10) Pub. No.: US 2008/0176134 A1
(43) Pub. Date: Jul. 24, 2008

(54) Case for secondary battery and battery pack including the same

(76) Inventor: Heong-Sin Kim, Suwon-si (KR)

Correspondence Address: ROBERT E. BUSHNELL, 1522 K STREET NW, SUITE 300, WASHINGTON, DC, 20005-1202, US

(21) Appl. No.: 12/003,845

(22) Filed: Jan. 2, 2008

(30) Foreign Application Priority Data
Jan. 19, 2007 (KR) 1020070006109

(51) Int. Cl. H01M 2/02; H01M 2/04

(52) U.S. Cl. 429/175; 429/176; 429/7

(57) ABSTRACT

A case for a secondary battery prevents reverse-insertion of a battery by having a step-shaped fastening groove formed in an upper case, the groove being connected to a fastening projection of a terminal of an electrical/electronic device. A battery pack includes the case. The battery pack further includes: a bare cell; a protection circuit board electrically connected to the bare cell; and an upper case disposed at the exterior of the bare cell and covering the protection circuit board, the upper case including a step-shaped fastening groove.

### CLAIM OF PRIORITY

This application makes reference to, incorporates the same herein, and claims all benefits accruing under 35 U.S.C. §119 from an application for CASE FOR SECONDARY BATTERY AND BATTERY PACK INCLUDING THE SAME earlier filed in the Korean Intellectual Property Office on the 19 Jan. 2007 and there duly assigned Serial No. 2007-0006109.

### BACKGROUND OF THE INVENTION

1. Technical Field

The present invention relates to a case for a secondary battery and a battery pack including the same and, more particularly, to a case for a secondary battery having a step-shaped fastening groove on an upper case to prevent reverse-insertion of the battery by fastening a terminal of an electrical/electronic device with a fastening projection to the fastening groove, and a battery pack including the same.

2. Related Art

Generally, as lightweight and high-performance structures are required in portable wireless devices, such as video cameras, mobile phones, and portable computers, secondary batteries used for their driving power sources have actively been researched. Examples of these secondary batteries include a nickel-cadmium battery, a nickel-metal hydride battery, a nickel-zinc battery, a lithium secondary battery, etc. The lithium secondary battery is rechargeable, compact and large in capacity, and thus is widely applied to high-tech electronic devices because of its high operating voltage and high energy density per unit weight.

The lithium secondary battery is manufactured by: installing a battery pack with an electrode assembly, including a cathode plate, an anode plate and a separator, a can containing the electric assembly, and safety devices such as a positive temperature coefficient (PTC) element, a thermal fuse and a protection circuit module, in a bare cell in which an upper opening of the can is sealed with a cap assembly; inserting the resulting assembly into a separate outer case or filling a gap with hot-melt resin; and tubing and labeling it with a thin exterior material.

Typically, the battery pack is mass-produced, built in a hard case like a battery for a current mobile phone, and then forwarded in the form of a hard pack. Alternatively, the battery pack is forwarded in the form of an inner pack (as it is generally called by those in the art) so that a user can insert the battery pack into a terminal for an electrical/electronic device for use. In the latter case, a conventional inner pack type battery pack has been used for exclusive application with a specific electrical/electronic device. However, with the recent trends toward compatible and standardized battery packs, the need for these battery packs to be applied to various electrical/electronic terminals arises.

In that regard, when a user inserts the battery pack into a terminal of an electrical/electronic device in a reverse direction, the electrical/electronic device may malfunction. Particularly, in this case, an external terminal of the battery pack may be short-circuited, and thus the battery pack may become useless, and may even catch fire or explode due to increased internal temperature.

To solve such a problem, a fastening groove is formed on a battery pack, a fastening projection is formed on a terminal of an electrical/electronic device, and the groove and the projection are fastened to each other, thereby preventing reverse-insertion of the battery pack into the terminal.

A battery pack comprises a case for a secondary battery, including an outer case, an upper case and a lower case, and a fastening groove is formed on the upper case. A terminal of an electrical/electronic device comprises a fastening projection fastened to the fastening groove of the battery pack on the terminal.

In this regard, the fastening projection is formed so as to be long in a horizontal direction of the terminal, and the fastening groove is also formed so as to be long in a horizontal direction of the upper case so as to be fastened to the long side of the fastening projection. Therefore, the fastening groove and the fastening projection are fastened to each other because of their corresponding shapes so that the battery pack and the terminal are fastened to each other.

In this regard, when the battery pack inserted into the terminal of the electrical/electronic device is upside down, a surface of the battery pack that does not have the fastening groove thereon encounters the fastening projection of the electrical/electronic device, but is not fastened to the fastening projection, thereby preventing reverse-insertion.

However, the battery pack may not be fastened to the terminal of the electrical/electronic device when the fastening groove of the battery pack is formed so as to be long in the vertical direction of the upper case and the fastening projection of the terminal is formed so as to be long in the horizontal direction. Also, the conventional battery pack may also not be fastened to the terminal when the fastening groove of the battery pack is formed so as to be long in the horizontal direction of the upper case and the fastening projection of the terminal is formed so as to be long in the vertical direction.

That is, in order to manufacture a compatible and standardized battery pack, the shape of the battery pack has to be changed depending on the fastening projection of the terminal of the electrical/electronic device. More specifically, the shape of the fastening groove of the upper case has to be changed.

Also, in manufacturing the battery pack, the shape of the fastening groove is determined by that of the fastening projection of the terminal.

### SUMMARY OF THE INVENTION

The present invention provides an upper case including a fastening groove applicable in the case where a fastening projection of a terminal of an electrical/electronic device is formed so as to be long in both the horizontal and the vertical directions.

The present invention also provides an upper case which can make a battery pack compatible and standardized when a fastening projection of the terminal of an electrical/electronic device is long in neither the horizontal direction nor the vertical direction.

According to an aspect of the present invention, a case for a secondary battery including an upper case, which comprises a step-shaped fastening groove, is provided.

According to another aspect of the present invention, a battery pack comprises: a bare cell; a protection circuit board electrically connected to the bare cell; and an upper case disposed at the exterior of the bare cell and covering the protection circuit board, the upper case including a step-shaped fastening groove.

The fastening groove may be formed at each of upper left and right sides of the upper case. The fastening groove may be formed at an upper left or right sides of the upper case.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1A is a perspective view of an example of a battery pack;

FIG. 1B is a perspective view of an example of a fastening projection on a terminal of an electrical/electronic device;

FIG. 1C is a perspective view of a state in which the battery pack of FIG. 1A and the terminal of the electrical/electronic device of FIG. 1B are fastened;

FIG. 2A is a perspective view of another example of a battery pack;

FIG. 2B is a perspective view of another example of a fastening projection on a terminal of an electrical/electronic device;

FIG. 2C is a perspective view of a state in which the battery pack of FIG. 2A and the terminal of the electrical/electronic device of FIG. 2B are fastened;

FIG. 3A is an exploded perspective view illustrating the structure of a battery pack according to an exemplary embodiment of the present invention;

FIG. 3B is a perspective view of the structure of a battery pack according to an exemplary embodiment of the present invention;

FIG. 3C is an expanded perspective view of region “A” of FIG. 3B;

FIGS. 4A and 4B are perspective views of a state in which a battery pack and a fastening projection on a terminal of an electrical/electronic device are fastened according to an exemplary embodiment of the present invention; and

FIGS. 5A and 5B are perspective views of a state in which a battery pack and a fastening projection on a terminal of an electrical/electronic device are fastened according to another exemplary embodiment of the present invention.

### DETAILED DESCRIPTION OF THE INVENTION

The above and other objects, features and functions of the present invention will be described more fully hereinafter. In the drawings, the thickness and length of layers and regions may be exaggerated for clarity. Like elements are denoted by like reference numerals throughout the drawings.

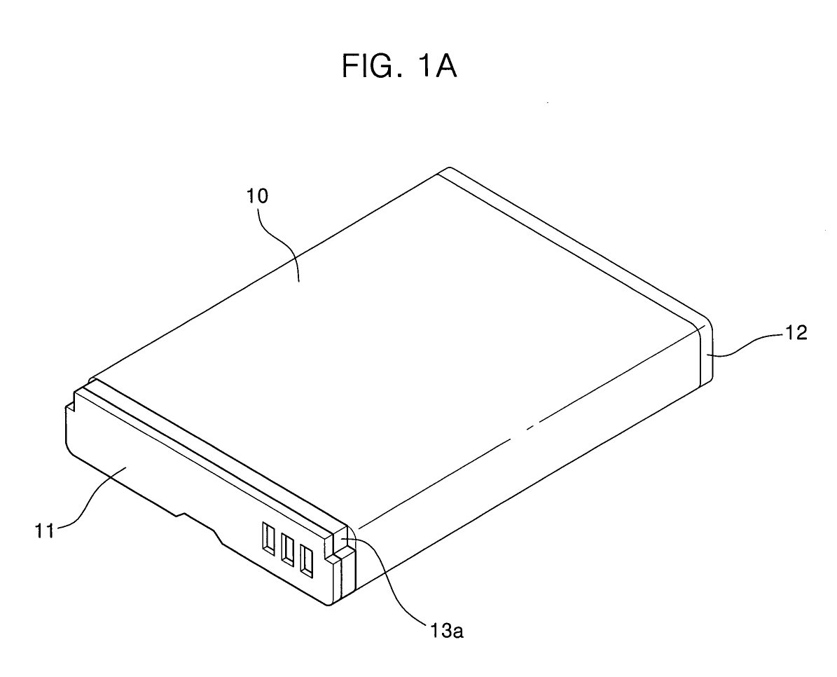

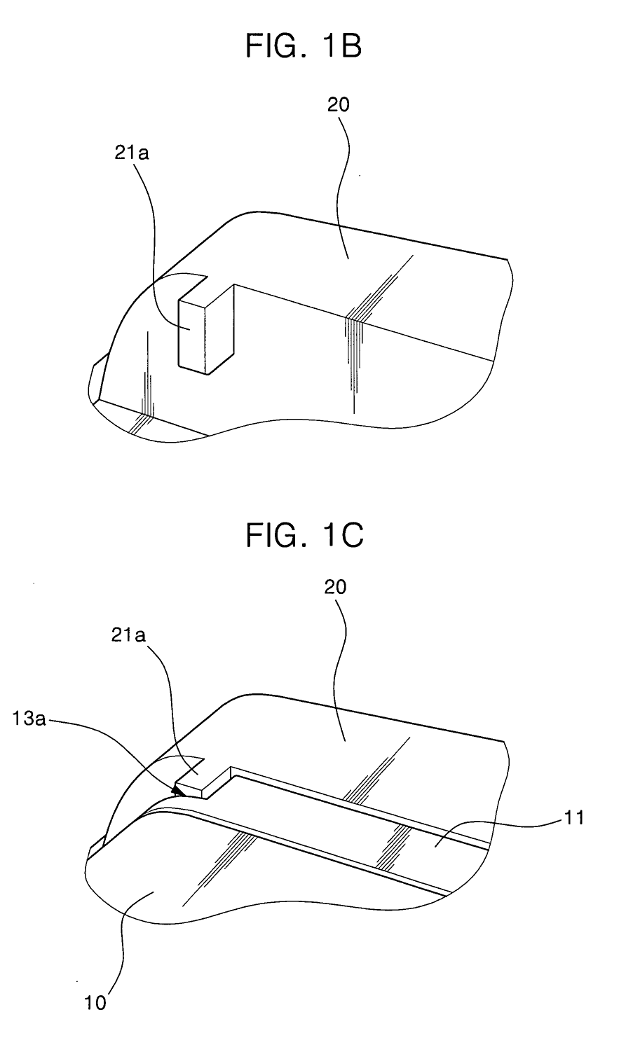

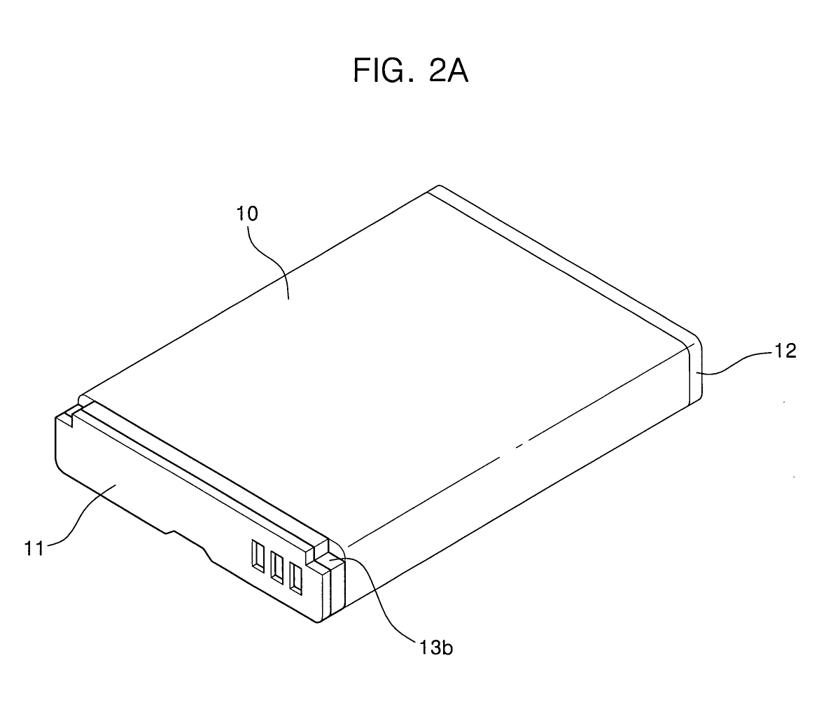

FIG. 1A is a perspective view of an example a battery pack, FIG. 1B is a perspective view of an example of a fastening projection on a terminal of an electrical/electronic device, and FIG. 1C is a perspective view of a state in which the battery pack of FIG. 1A and the terminal of the electrical/electronic device of FIG. 1B are fastened.

Referring to FIG. 1A, a battery pack comprises a case for a secondary battery including an outer case 10, an upper case 11 and a lower case 12, and a fastening groove 13a is formed on the upper case 11. Referring to FIG. 11B, a terminal 20 of an electrical/electronic device comprises a fastening projection 21a fastened to the fastening groove 13a of the battery pack on the terminal.

In this regard, the fastening projection 21a is formed so as to be long in a horizontal direction of the terminal in the drawing, and the fastening groove 13a is also formed so as to be long in a horizontal direction of the upper case 11 so as to be fastened to the long side of the fastening projection 21a. Therefore, the fastening groove 13a and the fastening projection 21a are fastened to each other because of their corresponding shapes, as illustrated in FIG. 1C, so that the battery pack and the terminal are fastened to each other.

In this regard, when the battery pack is inserted into the terminal of the electrical/electronic device upside down, a surface of the battery pack that does not have the fastening groove 13a thereon encounters the fastening projection 21a of the electrical/electronic device, but is not fastened to the fastening projection 21a, thereby preventing reverse-insertion.

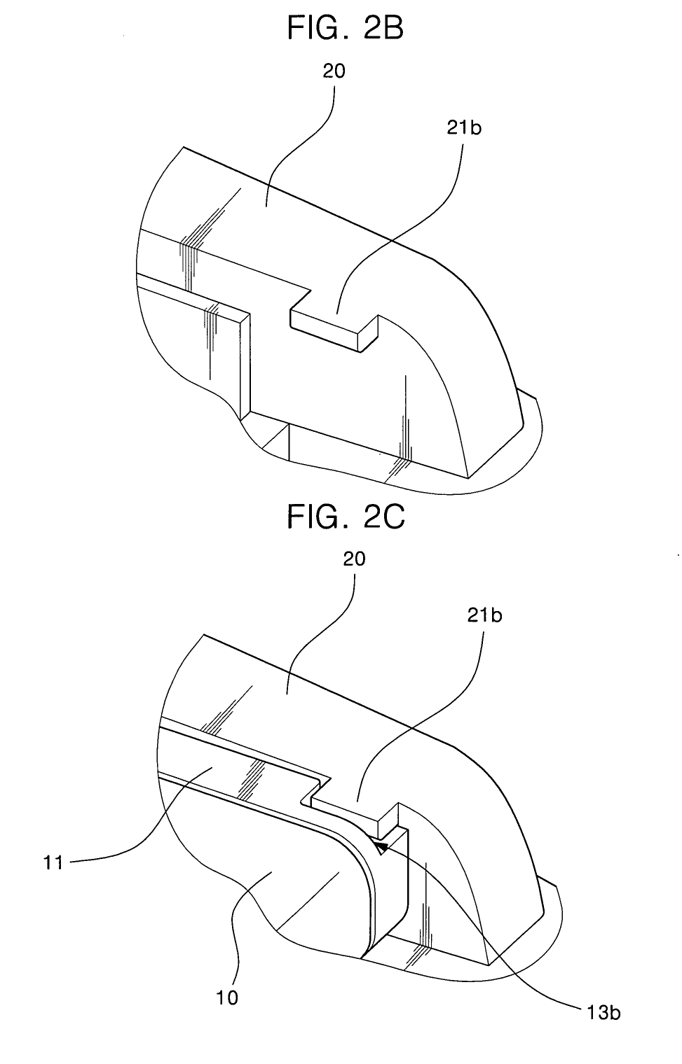

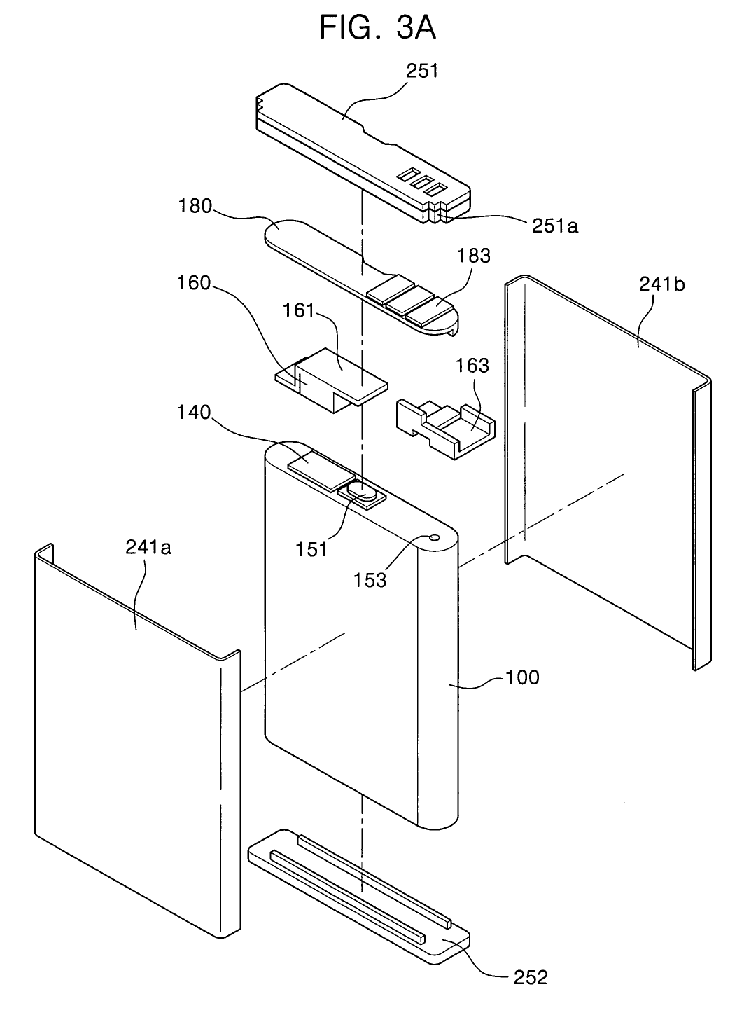

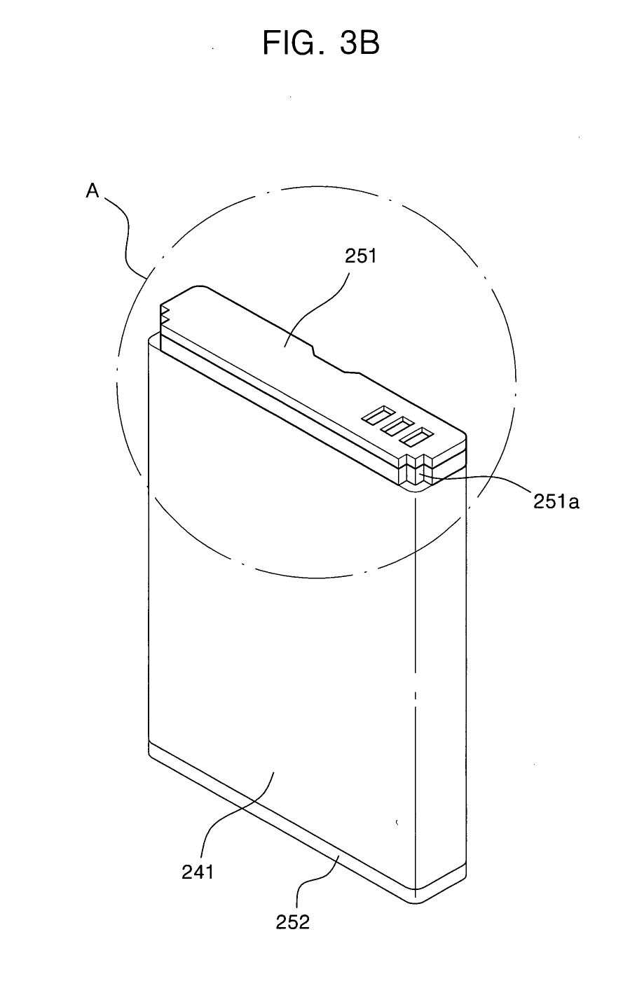

FIG. 2A is a perspective view of another example of a battery pack, FIG. 2B is a perspective view of another example of a fastening projection on a terminal of an electrical/electronic device, and FIG. 2C is a perspective view of a state in which the battery pack of FIG. 2A and the terminal of the electrical/electronic device of FIG. 2B are fastened.

Referring to FIG. 2A, a battery pack comprises a case for a secondary battery including an outer case 10, an upper case 11 and a lower case 12, and a fastening groove 13b is formed on the upper case 11. Referring to FIG. 2B, a terminal 20 of the electrical/electronic device has a fastening projection 21b which is fastened to the fastening groove 13b.

In this regard, the fastening projection 21b is formed so as to be long in a horizontal direction of the terminal in FIG. 2A, and the fastening groove 13b is also formed so as to be long in a horizontal direction of the upper case 11 and so as to be fastened to the long side of the fastening projection 21b. Therefore, the fastening groove 13b and the fastening projection 21b are fastened to each other because of their corresponding shapes, so that the battery pack and the terminal are fastened as illustrated in FIG. 2C.

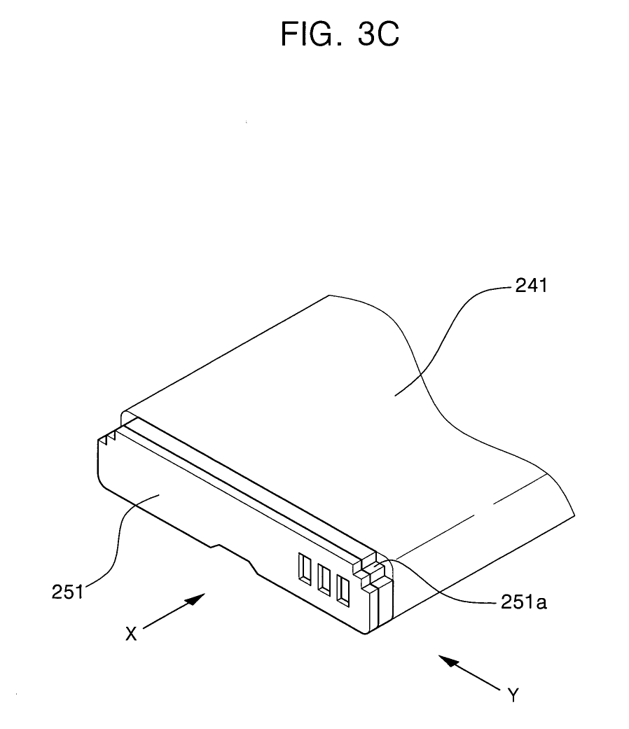

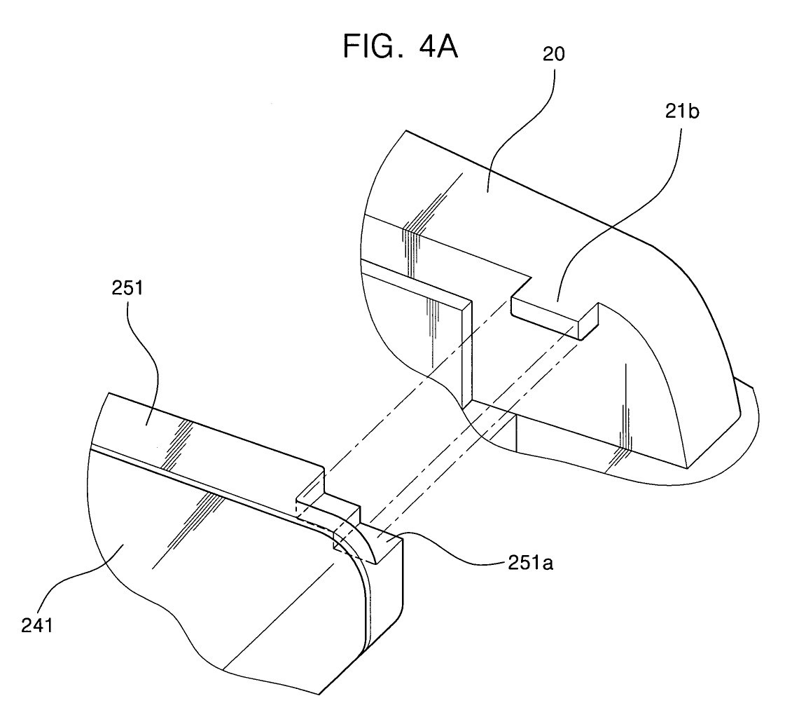

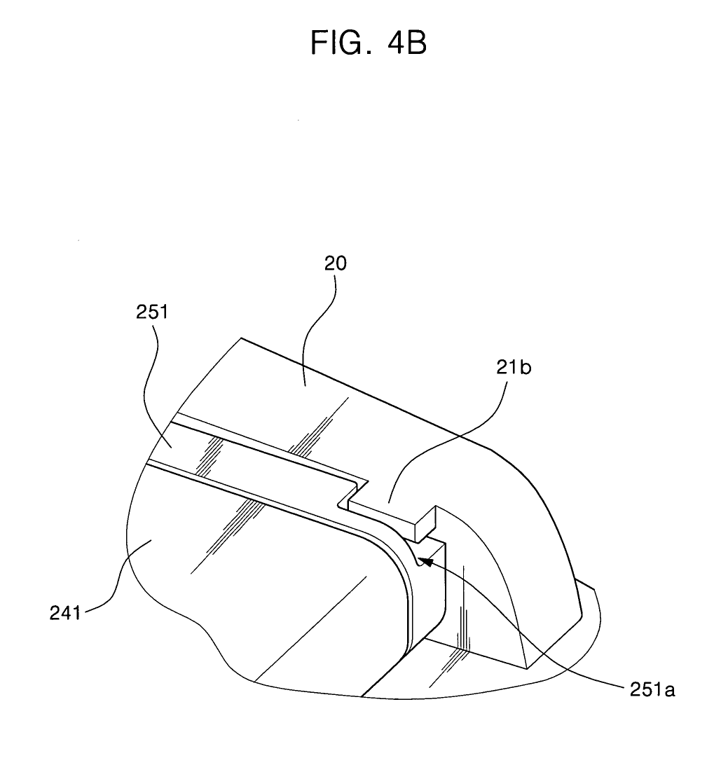

FIG. 3A is an exploded perspective view of the structure of a battery pack according to an exemplary embodiment of the present invention, FIG. 3B is a perspective view illustrating the structure of a battery pack according to an exemplary embodiment of the present invention, and FIG. 3C is an expanded perspective view of region “A” of FIG. 3B.

Referring to FIGS. 3A and 3B, a battery pack according to an exemplary embodiment of the present invention may comprise a bare cell 100, a protection circuit board 180 and a case for a secondary battery. The case for the secondary battery may comprise an outer case 241a and 241b, an upper case 251 and a lower case 252. The bare cell 100 is a secondary battery, such as a lithium ion battery, a nickel-metal hydride battery, a nickel-cadmium battery, etc., but it is not limited thereto.

The protection circuit board 180 is electrically connected to the bare cell 100. The protection circuit board 180 generally comprises various protection circuits and a positive temperature coefficient (PTC) thermistor 160 on a printed circuit board (PCB). Also, several outwardly exposed external terminals 183 are formed on the surface of the protection circuit board 180.

When the temperature of the bare cell 100 is higher than a predetermined temperature, the electric resistance of the PTC thermistor 160 of the protection circuit board 180 is almost infinite. Thus, when the bare cell 100 is exposed to high temperature, the PTC thermistor 160 regulates charging/discharging of the bare cell 100, and when the bare cell 100 is over-charged/discharged, the PTC thermistor 160 opens the circuit to prevent burst of the bare cell 100.

In this regard, an insulating member 140 is interposed between the bare cell 100 and the protection circuit board 180 so as to insulate the bare cell 100 from the protection circuit board 180. That is, the insulating member 140 serves to prevent direct contact between several electronic elements of the protection circuit board 180 and the surface of the bare cell 100, thereby preventing short circuits.

The protection circuit board 180 is electrically connected to the bare cell 100 through first and second electrode leads 161 and 163, respectively. That is, the first electrode lead 161 and second electrode lead 163 are connected to first electrode terminal 151 and second electrode terminal 153, respectively, of the bare cell 100, wherein the first electrode lead 161 may be welded to the first electrode terminal 151, and the second electrode lead 163 may be welded to the second electrode terminal 153. The first electrode lead 161 may be formed of an aluminum (Al) material, and the second electrode lead 163 may be formed of a nickel (Ni) material, but the present invention is not limited thereto. Meanwhile, the case for a secondary battery of the present invention may be composed of an outer case 241a and 241b, an upper case 251 and a lower case 252.

The outer case 241a, 241b is divided into a first outer case 241a and a second outer case 241b to cover the sides of the bare cell 100. In this regard, the outer case 241a, 241b may be formed of a metallic material or plastic resin. When the outer case 241a, 241b is formed of plastic resin, it may be formed lighter and thinner than when it is formed of a metallic material. In addition, since the outer case 241a, 241b is formed so as to have rounded corners, when the battery pack including the bare cell 100 is provided in an electronic device, their contact surfaces decrease, and thus the friction between the battery pack and the electronic device may be reduced.

Alternatively, the outer case 241a, 241b may be formed to contain the bare cell 100, not separated into first and second outer cases (this alternative is not illustrated in the drawings). However, the shape and structure of the outer case 241a, 241b in the present invention are not limited thereto.

Also, although not illustrated in the drawing, the outer case 241a, 241b may be omitted, and if so, a packaging label to be described later may cover the bare cell 100.

The upper case 251 may also be disposed on the bare cell 100, and the lower case 252 may be disposed beneath the bare cell 100. In this regard, when the outer case 241a, 241b is formed to cover the bottom of the bare cell 100, the lower case 252 may be omitted.

The upper case 251 may be formed in a single body type, an embedded type, or a cover type. The single body-type upper case 251 may be formed by connecting a protection circuit board 180 to the top surface of the battery cell, and projecting nylon-based synthetic resin is deposited onto the exterior of the protection circuit board 180 of the battery cell at low temperature and pressure.

The embedded-type upper case 251 may be formed by embedding the protection circuit board 180 into synthetic resin, and then connecting the upper case 251 to the top surface of the battery cell.

The cover-type upper case 251 may be formed by connecting a protection circuit board 180 to the top surface of the battery cell, and then connecting the upper case 251, which can be pre-formed of synthetic resin, to the battery cell to which the protection circuit board 180 is connected.

That is, the upper case 251 of the present invention may be formed by various methods as described above, but it is not limited thereto.

In this regard, the upper case 251 has a fastening groove 251a which can be connected with a fastening projection on a terminal of an electrical/electronic device. The fastening groove 251a, as illustrated in FIG. 3C, may be formed at upper right and left sides of the upper case 251, or at either the upper right or left side of the upper case 251, although this is not illustrated in this drawing.

Referring to FIG. 3C, the fastening groove 251a may be formed in a step-shaped structure when viewed from a side surface of the upper case 251, that is, from a Y direction.

That is, since the fastening groove 251a is formed so as to be long in horizontal and vertical directions of the upper case 251, it is formed in a “ [symbol] ” or “ [symbol] ” shape when viewed from an X direction, i.e., from the top of the upper case 251 (hereinafter, the structure is called a step-shaped structure in the present invention), whereas a another fastening groove maybe formed in an “|” or “-” shape.

In a battery pack, when the fastening groove is formed in the “|” shape, i.e., long in the vertical direction of the upper case, the fastening groove is not fastened to the terminal of the electric/electronic device having the fastening projection formed in the “-” shape, i.e., long in the horizontal direction. Also, when the fastening groove is formed in the “-” shape, i.e., long in the horizontal direction of the upper case, the fastening groove is not fastened to the terminal of the electric/electronic device having the fastening projection formed in the “|” shape, i.e., long in the vertical direction.

However, in the step-shaped structure of the present invention as described above, the fastening groove is formed in a “ [symbol] ” or “ [symbol] ” shape, i.e., long in both horizontal and vertical directions of the upper case 251, such that the groove 251a can be fastened to a terminal having a fastening projection which is long in the vertical direction or a fastening projection which is long in the horizontal direction.

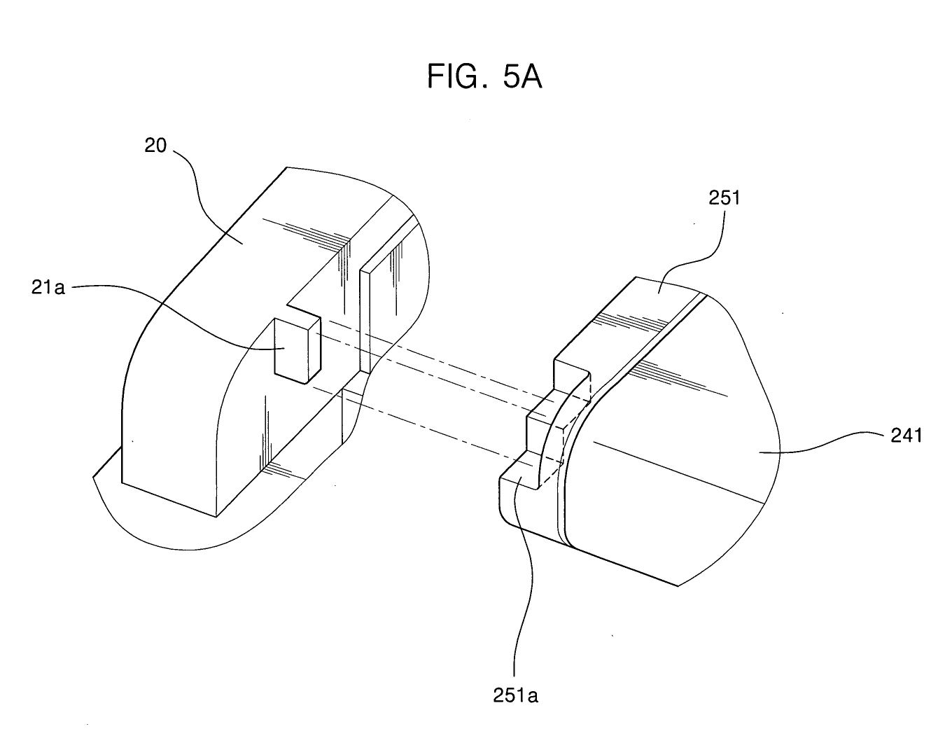

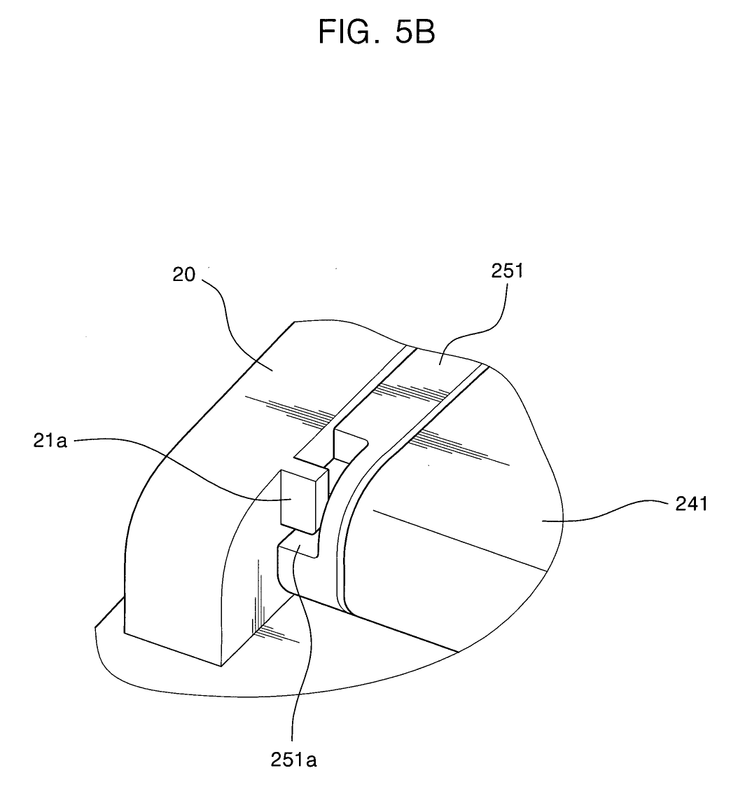

FIGS. 4A and 4B are perspective views of a state in which a battery pack and a fastening projection on a terminal of an electrical/electronic device are fastened according to an exemplary embodiment of the present invention, while FIGS. 5A and 5B are perspective views of a state in which a battery pack and a fastening projection on a terminal of an electrical/electronic device are fastened according to another exemplary embodiment of the present invention.

In this case, FIG. 4A is a perspective view before the battery pack and the fastening projection, which is formed in the “-” shape, i.e., long in the horizontal direction, are fastened according to an exemplary embodiment of the present invention, and FIG. 4B is a perspective view after the battery pack and the terminal of FIG. 4A are fastened.

Also, FIG. 5A is a perspective view before the battery pack and the fastening projection, which is formed in the “|” shape, i.e., long in the vertical direction, are fastened according to an exemplary embodiment of the present invention, and FIG. 5B is a perspective view after the battery pack and the terminal of FIG. 5A are fastened.

That is, as seen in FIGS. 4A and 4B, when the fastening projection 21b of the terminal 20 of an electrical/electronic device is formed so as to be long in the horizontal direction, the step-shaped fastening groove 251a is formed so as to be long in the horizontal direction of the upper case 251 and so as to enable fastening to the fastening projection 21b. Also, as seen in FIGS. 5A and 5B, when the fastening projection 21a of the terminal 20 of the electrical/electronic device is formed so as to be long in the vertical direction, the step-shaped fastening groove 251a of the present invention is formed so as to be long in the vertical direction of the upper case 251 and so as to enable fastening to the fastening projection 21a.

Thus, an upper case which includes a step-shaped fastening groove of the present invention may be applicable to both terminals of electrical/electronic devices having a fastening projection which is formed so as to be long in the vertical direction and a fastening projection which is formed so as to be long in the horizontal direction.

Although the fastening projection of the terminal of the electrical/electronic device formed in the “-” or “|” shape only is illustrated in the drawing, the fastening projection may be formed in the same shape as the fastening groove.

That is, the fastening projection of the terminal of the electrical/electronic device may be formed in the ” [symbol] ” or “ [symbol] ” shape, i.e., long in both horizontal and vertical directions according to the position of the fastening groove in the upper case.

In this case, compared to the fastening projection which is formed in the “-” or “|” shape, a unit contact area of the fastening groove increases, which results in reinforcement of the fastening strength between the battery pack and the terminal, and effective prevention of leftward and rightward movement of the battery pack.

Furthermore, a packaging label covering the outer case may be further included, which is not illustrated in the drawing. In this regard, the packaging label may cover an outer case containing a battery cell, an upper case, a protection circuit board and a lower case, which are assembled with each other.

The packaging label may also cover a battery cell, an upper case, a protection circuit board and a lower case, which are assembled with each other, even when the outer case is omitted in this case, the bottom of the upper case and the top of the lower case are attached by being covered with the packaging label, and thus the bonding strength between the upper and lower cases and the battery cell may be improved.

According to the present invention, an upper case including a fastening groove can be applicable to both fastening projections of terminals of electrical/electronic devices, which are formed so as to be long in the horizontal and vertical directions.

According to the present invention, a battery pack may be compatible and standardized regardless of when the fastening projection of the terminal of the electrical/electronic device is formed so as to be long in the horizontal direction or in the vertical direction.

Also, the reverse-insertion of the battery pack into the terminal of the electrical/electronic device may be prevented due to the structure of the fastening groove of the upper case.

According to the present invention, the fastening projection may be formed in the same shape as the fastening groove, thereby reinforcing the fastening strength between the battery pack and the terminal, and effectively preventing the leftward and rightward movement of the battery pack.

Although the present invention has been described with reference to certain exemplary embodiments thereof, it will be understood by those skilled in the art that a variety of modifications and variations may be made to the present invention without departing from the spirit or scope of the present invention as defined in the appended claims, and their equivalents.

What is claimed is:

1. A case for a secondary battery, comprising an upper case which includes a step-shaped fastening groove.

2. The case according to claim 1, wherein the fastening groove is formed in one of a “ [symbol] ” shape and a “ [symbol] ” shape when viewed from a top of the upper case.

3. The case according to claim 1, wherein the fastening groove is formed at each of upper left and right sides of the upper case.

4. The case according to claim 1, wherein the fastening groove is formed at one of an upper left side and an upper right side of the upper case.

5. A battery pack, comprising:
a bare cell;
a protection circuit board electrically connected to the bare cell; and
an upper case disposed at an exterior of the bare cell and covering the protection circuit board, wherein the upper case includes a step-shaped fastening groove.

6. The battery pack according to claim 5, wherein the fastening groove is formed in one of a “ [symbol] ” shape and a “ [symbol] ” shape when viewed from a top surface of the upper case.

7. The battery pack according to claim 5, wherein the fastening groove is formed at each of an upper left side and an upper right side of the upper case.

8. The battery pack according to claim 5, wherein the fastening groove is formed at one of an upper left side and an upper right side of the upper case.

9. The battery pack according to claim 5, wherein the upper case comprises a single body case.

10. The battery pack according to claim 5, wherein the upper case comprises an embedded-type case.

11. The battery pack according to claim 5, wherein the upper case comprises a cover-type case.
